(19) United States
(12) Patent Application Publication
(10) Pub. No.: US 2025/0020990 A1
(43) Pub. Date: Jan. 16, 2025

(54) AFOCAL OPTICAL ELEMENT AND PROJECTION DEVICE

(71) Applicant: Qisda Corporation, Taoyuan City (TW)

(72) Inventors: Chih-Shiung Chien, Taoyuan City (TW); Ming-Kuen Lin, Taoyuan City (TW); Ching-Tze Huang, Taoyuan City (TW)

(73) Assignee: Qisda Corporation, Taoyuan City (TW)

(21) Appl. No.: 18/748,040

(22) Filed: Jun. 19, 2024

(30) Foreign Application Priority Data
Jul. 14, 2023 (TW) 112126290

(51) Int. Cl. G03B 21/20; G02B 5/02

(52) U.S. Cl. CPC G03B 21/208; G02B 5/02; G03B 21/2033

(57) ABSTRACT

An afocal optical element adapted to reduce a beam diameter of a light beam is provided. The afocal optical element includes an object-side surface facing an object-side through which the light beam passes and an image-side surface facing an image-side through which the light beam passes. The object-side surface is convex, and the image-side surface is concave. The afocal optical element has only one lens element. In addition, a projection device is also provided.

### CROSS-REFERENCE TO RELATED APPLICATION

This application claims the priority benefit of Taiwan application serial no. 112126290, filed on Jul. 14, 2023. The entirety of the above-mentioned patent application is hereby incorporated by reference herein and made a part of this specification.

### BACKGROUND

### Technical Field

The disclosure relates to an optical element and an electronic device, and more particularly to an afocal optical element and a projection device.

### Description of Related Art

The projection device is a display device for producing large-scale images, and has been continuously improving with the evolution and innovation of technology. The imaging principle of the projection device is to convert the lighting beam generated by the lighting system into an image light beam through a light valve, and then project the image light beam to the projection target (such as a screen or a wall) through a projection lens to form a projection image. In addition, the lighting system also follows the market requirements for the brightness, color saturation, service life, non-toxic and environmental protection of projection devices, etc., and has evolved from the ultra-high-performance lamp (UHP lamp) to the light-emitting diode (LED), and to the currently most advanced laser diode (LD) light source in order to make the internal configuration of the projection device more compact and provide better optical performance. In the current combined light system, the general design of the afocal system uses two lenses, one of which is a convex lens element and the other is a concave lens element. Through the design of the curvature and position of the two lenses, the diameter of the parallel light beam may be reduced. However, although the above design may significantly reduce the diameter of the parallel light beam, a larger space and higher cost are required.

### SUMMARY

The disclosure provides an afocal optical element and a projection device that may occupy a smaller space and require a lower cost, making the projection device smaller in size.

The disclosure provides an afocal optical element, adapted to reduce a beam diameter of a light beam. The afocal optical element includes an object-side surface facing an object-side through which the light beam passes and an image-side surface facing an image-side through which the light beam passes. The object-side surface is convex, and the image-side surface is concave. The afocal optical element has only one lens element.

In one embodiment of the disclosure, the afocal optical element is a meniscus lens.

In one embodiment of the disclosure, the afocal optical element is a spherical lens.

In one embodiment of the disclosure, a material of the afocal optical element is glass.

In one embodiment of the disclosure, a refractive index of the afocal optical element is greater than or equal to 1.70 and less than or equal to 1.90.

In one embodiment of the disclosure, the afocal optical element satisfies the following conditional formula: 0.5≤R2/R1<1. R2 is a radius of curvature of the image-side surface, and R1 is a radius of curvature of the object-side surface.

In one embodiment of the disclosure, the afocal optical element satisfies the following conditional formula: 0.5≤D2/D1<1. D2 is a beam diameter of the light beam after passing through the afocal optical element, and D1 is the beam diameter of the light beam before passing through the afocal optical element.

In one embodiment of the disclosure, a radius of curvature of the object-side surface is greater than or equal to 4.1 and less than or equal to 5.2.

In one embodiment of the disclosure, a radius of curvature of the image-side surface is greater than or equal to 2.8 and less than or equal to 3.9.

In one embodiment of the disclosure, the light beam is a parallel light before entering the afocal optical element, and the light beam coming from the afocal optical element is also a parallel light.

The disclosure provides a projection device, including a lighting system, a light valve, and a projection lens. The lighting system is adapted to provide a lighting beam. The lighting system includes a light source module and an afocal optical element. The light source module provides a light beam. The afocal optical element is disposed on a transmission path of the light beam and is adapted to reduce a beam diameter of the light beam. The afocal optical element includes an object-side surface facing an object-side through which the light beam passes and an image-side surface facing an image-side through which the light beam passes. The object-side surface is convex, and the image-side surface is concave. The afocal optical element has only one lens element. The light valve is disposed on a transmission path of the lighting beam to convert the lighting beam into an image beam. The projection lens is disposed on a transmission path of the image beam and adapted to project the image beam out of the projection device.

In one embodiment of the disclosure, the afocal optical element is a meniscus lens.

In one embodiment of the disclosure, the afocal optical element is a spherical lens.

In one embodiment of the disclosure, a material of the afocal optical element is glass.

In one embodiment of the disclosure, a refractive index of the afocal optical element is greater than or equal to 1.70 and less than or equal to 1.90.

In one embodiment of the disclosure, the afocal optical element satisfies the following conditional formula: 0.5≤R2/R1<1. R2 is a radius of curvature of the image-side surface, and R1 is a radius of curvature of the object-side surface.

In one embodiment of the disclosure, the afocal optical element satisfies the following conditional formula: 0.5≤D2/D1<1. D2 is a beam diameter of the light beam after passing through the afocal optical element, and D1 is the beam diameter of the light beam before passing through the afocal optical element.

In one embodiment of the disclosure, a radius of curvature of the object-side surface is greater than or equal to 4.1 and less than or equal to 5.2, and a radius of curvature of the image-side surface is greater than or equal to 2.8 and less than or equal to 3.9.

In one embodiment of the disclosure, the light beam is a parallel light before entering the afocal optical element, and the light beam coming from the afocal optical element is also a parallel light.

In one embodiment of the disclosure, the light source module includes multiple laser light-emitters respectively providing multiple sub-light beams to form the light beam. The laser light-emitters are arranged in an array arrangement.

Based on the above, in the afocal optical element and the projection device of the disclosure, the afocal optical element is disposed on the transmission path of the light beam in the lighting system to reduce the beam diameter of the light beam. The afocal optical element includes an object-side surface facing an object-side through which the light beam passes and an image-side surface facing an image-side through which the light beam passes. The object-side surface is convex, and the image-side surface is concave. The afocal optical element has only one lens element. In this way, compared with the existing technology of using two optical lens elements for reducing the beam diameter, since the afocal optical element uses a single optical lens element, a smaller space in the lighting system is occupied and a lower cost is required, thereby making the projection device smaller in size.

In order to make the aforementioned and other features and advantages of the present invention more comprehensible, several embodiments accompanied with figures are described in detail below.

### BRIEF DESCRIPTION OF THE DRAWINGS

FIG. 1 is a schematic diagram of the projection device according to one embodiment of the disclosure.

FIG. 2 is a schematic diagram of the afocal optical element according to one embodiment of the disclosure.

### DESCRIPTION OF THE EMBODIMENTS

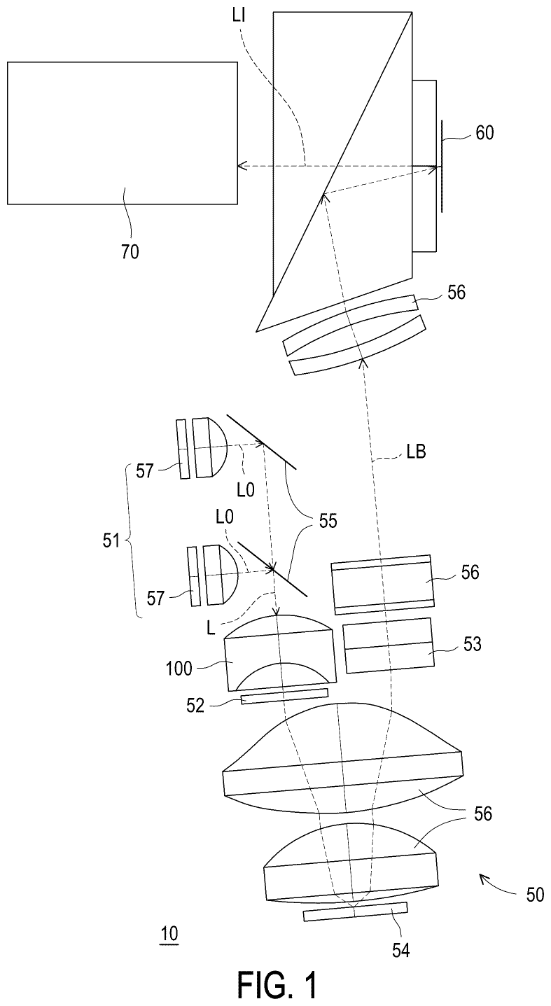

FIG. 1 is a schematic diagram of the projection device according to one embodiment of the disclosure. Referring to FIG. 1, this embodiment provides a projection device 10, including a lighting system 50, a light valve 60, and a projection lens 70. The lighting system 50 is adapted to provide a lighting beam LB. The light valve 60 is disposed on a transmission path of the lighting beam LB to convert the lighting beam LB into an image beam LI. The projection lens 70 is disposed on a transmission path of the image beam LI, and adapted to project the image beam LI out of the projection device 10 to a projection target (not shown), such as a screen or a wall.

The lighting system 50 is adapted to provide a lighting beam LB. For example, in this embodiment, the lighting system 50 is, for example, formed of a light source module 51, a diffusion element 52, a light homogenizing element 53, a reflective element 54, a beam splitting element 55, and/or a lens element 56 in order to provide lights with different wavelengths to form an image beam LI. The light source module 51 is adapted to provide a light beam L. In this embodiment, the light source module 51 includes, for example, multiple laser light-emitters 57, respectively providing multiple sub-light beams L0 to form the light beam L, and the laser light-emitters 57 are arranged in an array arrangement. However, the disclosure does not limit the type or form of the lighting system 50 in the projection device 10, and the detailed structure and implementation therefor can be described later and can be obtained from general knowledge in the technical field with sufficient teaching, suggestion, and implementation description.

The light valve 60 is, for example, a reflective light modulator such as a liquid crystal on silicon panel (LCoS panel) and a digital micro-mirror device (DMD). In some embodiments, the light valve 60 may also be a transmissive optical modulator, such as a transparent liquid crystal panel, an electro-optical modulator, a magneto-optical modulator, or an acousto-optic modulator (AOM), etc. The disclosure does not limit the form and type of the light valve 60. The detailed process and implementation of the method for the light valve 60 to convert the lighting beam LB into the image beam LI can be obtained from general knowledge in the technical field with sufficient teaching, suggestion, and implementation description and are not repeated herein.

The projection lens 70 includes, for example, a combination of one or more optical lenses with diopter, such as various combinations of non-planar lenses such as biconcave lenses, biconvex lenses, meniscus lenses, convex-concave lenses, plano-convex lenses, and plano-concave lenses. In one embodiment, the projection lens 70 may further include a flat optical lens to project the image beam LI from the light valve 60 to the projection target in a reflective manner. The disclosure does not limit the form and type of the projection lens 70.

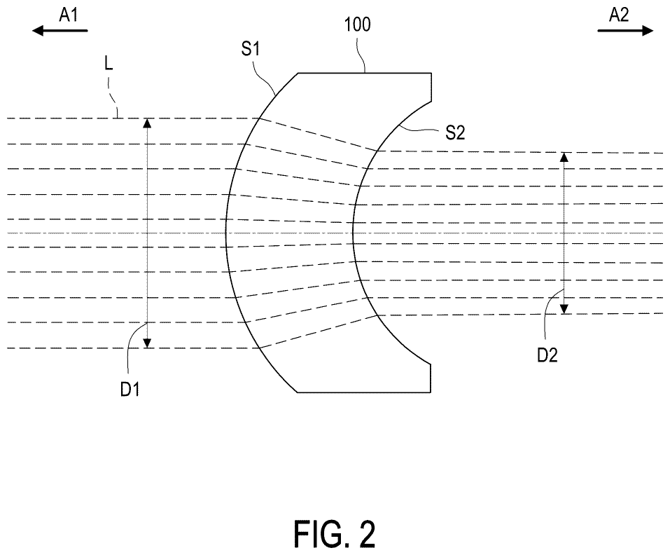

FIG. 2 is a schematic diagram of the afocal optical element according to one embodiment of the disclosure. The afocal optical element 100 of this embodiment may at least be applied to the projection device 10 shown in FIG. 1, so the following uses this as an example for description. Referring to both FIG. 1 and FIG. 2, the lighting system 50 includes the afocal optical element 100, which is disposed on the transmission path of the light beam L and is adapted to reduce the beam diameter of the light beam L. Specifically, in this embodiment, the afocal optical element 100 is disposed on the transmission path of the light beam L from the light source module 51, and is located between the light source module 51 and the diffusion element 52, but the disclosure is not limited thereto. It should be noted that the afocal optical element 100 has only one lens element, and the light beam L is a parallel light before entering the afocal optical element 100, and the light beam L coming from the afocal optical element 100 is also a parallel light. In other words, this embodiment may achieve the purpose of reducing the beam diameter of the light beam L with a single optical lens element. In this way, compared with the existing technology of using two optical lens elements for reducing the beam diameter, a smaller space in the lighting system 50 is occupied and a lower cost is required, thereby making the projection device 10 smaller in size.

Specifically, in this embodiment, the afocal optical element 100 includes an object-side surface S1 facing an object-side A1 through which the light beam L passes and an image-side surface S2 facing an image-side A2 through which the light beam L passes. The object-side surface S1 is convex, and the image-side surface S2 is concave. In other words, the afocal optical element 100 is a meniscus lens. In this embodiment, the afocal optical element 100 is a spherical lens and the material thereof may be glass, which has a refractive index of greater than or equal to 1.70 and less than or equal to 1.90. In this way, using materials with a higher refractive index for manufacturing may make the required thickness of the afocal optical element 100 thinner, thereby achieving smaller size and easier manufacturing, but the disclosure is not limited thereto. In addition, in this embodiment, the afocal optical element 100 satisfies the conditional formula: 0.5≤R2/R1<1. R2 is a radius of curvature of the image-side surface S2, and R1 is a radius of curvature of the object-side surface S1. In the case where the ratio of R2 to R1 is less than 0.5, the radius of curvature of the image-side surface S2 is too small to be easily manufactured. In other words, under this condition, the afocal optical element 100 may be manufactured more easily, making the lens element more stable and less likely to break, and reducing manufacturing costs.

Specifically, in the afocal optical element 100, the radius of curvature of the object-side surface S1 is greater than or equal to 4.1 and less than or equal to 5.2, and the radius of curvature of the image-side surface S2 is greater than or equal to 2.8 and less than or equal to 3.9. For example, in this embodiment, the refractive index of the afocal optical element 100 is 1.834, the radius of curvature of the object-side surface S1 is 4.67, and the radius of curvature of the image-side surface S2 is 3.33. Thus, the beam diameter D1 of the light beam L before beam reduction may be reduced to the beam diameter D2 of the light beam L after beam reduction, and the ratio of the beam diameter D2 to the beam diameter D1 is 0.71. In this way, compared with the existing technology of using two optical lens elements for reducing the beam diameter, since the afocal optical element 100 in this embodiment uses a single optical lens element, a smaller space in the lighting system 50 is occupied and a lower cost is required, thereby making the projection device 10 smaller in size.

To sum up, in the afocal optical element and the projection device of the disclosure, the afocal optical element is disposed on the transmission path of the light beam in the lighting system to reduce the beam diameter of the light beam. The afocal optical element includes an object-side surface facing an object-side through which the light beam passes and an image-side surface facing an image-side through which the light beam passes. The object-side surface is convex, and the image-side surface is concave. The afocal optical element has only one lens element. In this way, compared with the existing technology of using two optical lens elements for reducing the beam diameter, since the afocal optical element uses a single optical lens element, a smaller space in the lighting system is occupied and a lower cost is required, thereby making the projection device smaller in size.

Although the disclosure has been described in detail with reference to the above embodiments, they are not intended to limit the disclosure. Those skilled in the art should understand that it is possible to make changes and modifications without departing from the spirit and scope of the disclosure. Therefore, the protection scope of the disclosure shall be defined by the following claims.

What is claimed is:

1. An afocal optical element, adapted to reduce a beam diameter of a light beam and comprising an object-side surface facing an object-side through which the light beam passes and an image-side surface facing an image-side through which the light beam passes, wherein the object-side surface is convex, the image-side surface is concave, and the afocal optical element has only one lens element.

2. The afocal optical element according to claim 1, wherein the afocal optical element is a meniscus lens.

3. The afocal optical element according to claim 1, wherein the afocal optical element is a spherical lens.

4. The afocal optical element according to claim 1, wherein a material of the afocal optical element is glass.

5. The afocal optical element according to claim 1, wherein a refractive index of the afocal optical element is greater than or equal to 1.70 and less than or equal to 1.90.

6. The afocal optical element according to claim 1, wherein the afocal optical element satisfies the following conditional formula:
0.5≤R2/R1<1, wherein R2 is a radius of curvature of the image-side surface, and R1 is a radius of curvature of the object-side surface.

7. The afocal optical element according to claim 1, wherein the afocal optical element satisfies the following conditional formula:
0.5≤D2/D1<1, wherein D2 is a beam diameter of the light beam after passing through the afocal optical element, and D1 is the beam diameter of the light beam before passing through the afocal optical element.

8. The afocal optical element according to claim 1, wherein a radius of curvature of the object-side surface is greater than or equal to 4.1 and less than or equal to 5.2.

9. The afocal optical element according to claim 1, wherein a radius of curvature of the image-side surface is greater than or equal to 2.8 and less than or equal to 3.9.

10. The afocal optical element according to claim 1, wherein the light beam is a parallel light before entering the afocal optical element, and the light beam coming from the afocal optical element is also a parallel light.

11. A projection device, comprising:
a lighting system, adapted to provide a lighting beam, the lighting system comprising:
a light source module, providing a light beam; and
an afocal optical element, disposed on a transmission path of the light beam and adapted to reduce a beam diameter of the light beam,
wherein the afocal optical element comprises an object-side surface facing an object-side through which the light beam passes and an image-side surface facing an image-side through which the light beam passes, and
the object-side surface is convex, the image-side surface is concave, and the afocal optical element has only one lens element,
a light valve, disposed on a transmission path of the lighting beam to convert the lighting beam into an image beam; and
a projection lens, disposed on a transmission path of the image beam and adapted to project the image beam out of the projection device.

12. The projection device according to claim 11, wherein the afocal optical element is a meniscus lens.

13. The projection device according to claim 11, wherein the afocal optical element is a spherical lens.

14. The projection device according to claim 11, wherein a material of the afocal optical element is glass.

15. The projection device according to claim 11, wherein a refractive index of the afocal optical element is greater than or equal to 1.70 and less than or equal to 1.90.

16. The projection device according to claim 11, wherein the afocal optical element satisfies the following conditional formula:
0.5≤R2/R1<1, wherein R2 is a radius of curvature of the image-side surface, and R1 is a radius of curvature of the object-side surface.

17. The projection device according to claim 11, wherein the afocal optical element satisfies the following conditional formula:
0.5≤D2/D1<1, wherein D2 is a beam diameter of the light beam after passing through the afocal optical element, and D1 is the beam diameter of the light beam before passing through the afocal optical element.

18. The projection device according to claim 11, wherein a radius of curvature of the object-side surface is greater than or equal to 4.1 and less than or equal to 5.2, and a radius of curvature of the image-side surface is greater than or equal to 2.8 and less than or equal to 3.9.

19. The projection device according to claim 11, wherein the light beam is a parallel light before entering the afocal optical element, and the light beam coming from the afocal optical element is also a parallel light.

20. The projection device according to claim 11, wherein the light source module comprises a plurality of laser light-emitters respectively providing a plurality of sub-light beams to form the light beam, and the laser light-emitters are arranged in an array arrangement.
